(19) United States
(12) Patent Application Publication
(10) Pub. No.: US 2008/0042386 A1
(43) Pub. Date: Feb. 21, 2008

(54) Wheeled work chair

(76) Inventor: John E. Larson, Hamilton, MT (US)

Correspondence Address: John E. Larson, P.O. Box 1197, Hamilton, MT, 59840-1197, US

(21) Appl. No.: 11/974,556

(22) Filed: Oct. 15, 2007

Related U.S. Application Data
(63) Continuation of application No. 10/973,763, filed on Oct. 25, 2004, now Pat. No. 7,281,724.
(60) Provisional application No. 60/513,787, filed on Oct. 23, 2003.
(60) Provisional application No. 60/513,788, filed on Oct. 23, 2003.

(51) Int. Cl. B62B 9/00

(52) U.S. Cl. 280/47.41

(57) ABSTRACT

A wheeled work chair has all the attributes and style of an office chair but is equipped with wheelchair-type supporting wheels. The chair is height adjustable with the upper portion of the chair moving relative to the lower portion of the chair. Wheels connected to the upper portion of the chair move with the chair seat as the height of the chair is adjusted. Wheels connected to the lower portion of the chair remain on the ground as the height of the chair is adjusted. A static surface is provided on the arm of a height adjustable chair to support the weight of a user while that chair is being raised.

### CROSS-REFERENCE TO RELATED APPLICATIONS

The subject application is a continuation of co-pending U.S. patent application Ser. No. 10/973,763, filed Oct. 25, 2004, which claims the benefits of U.S. Provisional Application Ser. No. 60/513,787, filed Oct. 23, 2003 and U.S. Provisional Application Ser. No. 60/513,788, filed Oct. 23, 2003. These applications are herein incorporated by reference in their entirety.

### BACKGROUND OF THE INVENTION

Modern work chairs are ergonomically designed with the primary objective of preventing health problems resulting from inappropriate postural positioning of the seated worker, and also the numerous health problems resulting from static work postures over an extended period of time. Many of the remedies afforded by these ergonomic innovations involve either active or passive adjustments for selectively changing the postural positioning by the seated worker. Oftentimes ergonomic posture positioning adjustments have the added advantage of fitting the chair to multiple users having different body measurements, and also of allowing individual users the adjustment options for working at various height work surfaces. Similarly, these chair adjustments oftentimes allow seated workers to adjust their chairs for access to various height-placed work objects such as microscopes set on high counters for part of the work day, and then for example, a keyboard set at a much lower height for another part of the work day. Height adjustment is the most often used chair adjustment in the seated workplace.

Also, modern work chairs have been continually designed and redesigned to make them comfortable for seated workers, as worker comfort translates to worker productivity. Modern work chairs now offer seats of breathable fabrics, lumbar supports, sculpted seat cushions, and adjustable backrests and footrests. Modern work chairs provide many of these features while maintaining a sleek and attractive overall design.

Persons confined to a wheelchair experience more health problems relating to postural stasis than ordinary seated workers, and seldom are able to utilize any of the ergonomic benefits, or stylish design attributes afforded ordinary workers the seated workplace. A wheelchair-type chair with the ergonomic innovations and design attributes of a modern work chair would offer a user approximately the same health and comfort benefits as those provided an ordinary seated worker, while providing conformity with the style and design of the overall workplace environment.

All patents, patent applications, provisional patent applications and publications referred to or cited herein, are incorporated by reference in their entirety to the extent they are not inconsistent with the explicit teachings of the specification.

### SUMMARY OF THE INVENTION

The invention involves a wheeled work chair. The chair can gave the ergonomic functions and style of a modern work chair yet be equipped with wheelchair-type supporting wheels. This allows a disabled person to move about a workplace without use of his or her feet. In a preferred embodiment, the chair is height adjustable with the upper portion of the chair moving relative to the lower portion of the chair, with the wheels attached to the upper portion. In this embodiment, the wheels move with the chair seat as the height of the chair is adjusted, thus allowing the seat to spin about in concert with the wheels. This allows the user to benefit from the swivel features of modem work chairs without the typical problem that would be experienced with standard wheelchairs, that being the bumping of user's legs into stationary wheels during chair seat spin. In one embodiment where the wheels are connected to the lower portion of the wheeled work chair, approximately the same swivel limitations as standard wheelchairs exist, because as the wheels remain stationary on the ground whether the height of the chair is adjusted or not, the user's legs would swivel into the stationary wheels, unless the chair seat were adjusted high enough over the wheels to clear obstruction with the stationarily grounded wheels. In a particularly preferred embodiment of the wheeled work chair, whether the wheels are secured to the upper portion or the lower portion, a pair of push-off arm rests are provided allowing the user to transfer her or his weight from the chair seat making up the upper portion of the chair, to the base making up the lower portion of the chair. This allows an assistant to raise the chair seat, or add an additional seat cushion without user evacuation from the chair. In a most preferred embodiment, a remote actuator is provided proximate one of the push-off arm rests which allows the user to raise the chair seat without using his or her feet, without evacuating the chair, and without assistance from another person. An example of benefiting from this most preferred embodiment is that a worker confined to a chair can move herself or himself from a desk work area, over to a copy machine, and raise himself or herself to a height required to operate the copy machine without assistance from another person. In a home or community environment, this most preferred embodiment would allow a user to reach and access many essential objects that might otherwise be impossible in a standard wheelchair. This most preferred embodiment is also helpful in assisting the user to transfer from the wheeled work chair to a bathtub, another chair, into a car seat, or onto a bed. In a hospital or nursing home environment, this most preferred embodiment would serve to assist a healthcare worker, or the user, independent of a healthcare worker, into a height positioned bed or gurney. In other version of this most preferred embodiment, a second remote actuator is mounted on the upper portion of the wheeled work chair allowing a user to adjust the chair downward. In yet another version, any number of remote actuators can be mounted on upper portion armrests for actuating seat tilt, back tilt, footrest adjustments, or any other ergonomic mechanisms the wheeled work chair might provide.

### BRIEF DESCRIPTION OF THE DRAWINGS

FIG. 1 shows a side view of a preferred embodiment of the wheeled work chair of the subject invention with the wheels connected to the upper portion of the chair.

FIG. 2 shows a front view of the wheeled work chair shown in FIG. 1.

FIG. shows a side view of the wheeled work chair shown in FIG. 1 where the height of the chair has been adjusted upward.

FIG. 4 shows a front view of the wheeled work chair shown in FIG. 1 where the height of the chair has been adjusted upward.

FIG. 5 shows a front view of another preferred embodiment of the wheeled work chair of the subject invention that has adjustable push-off arm rests.

FIG. 6 shows a front view of the wheeled work chair shown in FIG. 5 where the height of the chair has been adjusted upward.

FIG. 7 shows a side view of another preferred embodiment of the wheeled work chair of the subject invention.

FIG. 8 shows a front view of another preferred embodiment of the wheeled work chair of the subject invention with the wheels connected to the lower portion of the chair.

FIG. 9 shows a side view of another preferred embodiment of the wheeled work chair of the subject invention with the wheels connected to the upper portion of the chair.

FIG. 10 shows a side view of another preferred embodiment of the wheeled work chair of the subject invention with the wheels connected to the lower portion of the chair.

FIG. 11 shows another preferred embodiment of the wheeled work chair of the subject invention with the wheels connected to the lower portion of the chair which includes a base with upwardly extending legs.

FIG. 12 shows a side view of another preferred embodiment of the wheeled work chair of the subject invention with the wheels connected to the upper portion of the chair.

FIG. 13 shows a side view of the wheeled work chair shown in FIG. 12 with the wheels connected to the upper portion of the chair.

FIG. 14 shows a side view of the wheeled work chair shown in FIG. 12 with the wheels connected to the upper portion of the chair.

FIG. 15 shows a side view of another preferred embodiment of the wheeled work chair of the subject invention with the wheels connected to the lower portion.

FIG. 16 shows a side view of the wheeled work chair shown in FIG. 15 with the wheels connected to the lower portion.

FIG. 17 shows a side view of the wheeled work chair shown in FIG. 15 with the wheels connected to the lower portion.

FIG. 18 shows a side view of the wheeled work chair shown in FIG. 15 with the wheels connected to the lower portion.

FIG. 19 shows a side view of another preferred embodiment of the wheeled work chair of the subject invention with the wheels connected to the lower portion.

FIG. 20 shows a side view of another preferred embodiment of the wheeled work chair of the subject invention with the wheels connected to the upper portion.

FIG. 21 shows a side view of the wheeled work chair shown in FIG. 20 with the seat position adjusted upward.

FIG. 22 shows a side view of another embodiment of the wheeled work chair shown in FIG. 20 with the wheels connected to the lower portion.

FIG. 23 shows a side view of the wheeled work chair shown in FIG. 22 with the seat position adjusted.

FIG. 24 shows another preferred embodiment of the wheeled work chair of the subject invention.

FIG. 25 shows another preferred embodiment of the wheeled work chair of the subject invention.

### DETAILED DESCRIPTION OF THE INVENTION

The subject invention provides a wheelchair without the traditional frame. The wheeled work chair of the subject invention provides the ergonomic benefits, comfort, and style of a conventional office chair.

The subject invention has a lower portion and an upper portion that can move relative to the lower portion. The subject invention has an height adjustment mechanism 11 supported on the lower portion which supports and moves a seat support mechanism to adjustable heights. The seat support mechanism positionally supports a chair seat.

The subject chair has wheelchair-type wheels mounted to a chair. The chair is height adjustable to adapt to different task ergonomic configurations. An upper portion moves relative to the lower portion of the chair. Wheels mounted on the stationary, lower portion do not rise on height adjustment. Wheels mounted on the upper moving portion rise with the chair seat and leave the ground as the chair is adjusted upward. To accomplish height adjustment for a seated person who is unable to use their legs the subject chair can be fitted with a push-off arm rest supporting mechanism. The push-off arm rest supporting mechanism 42 is stationarily supported directly by the lower portion allowing a person to transfer their body weight with their arms to the lower portion thereby allowing the seat to be raised.

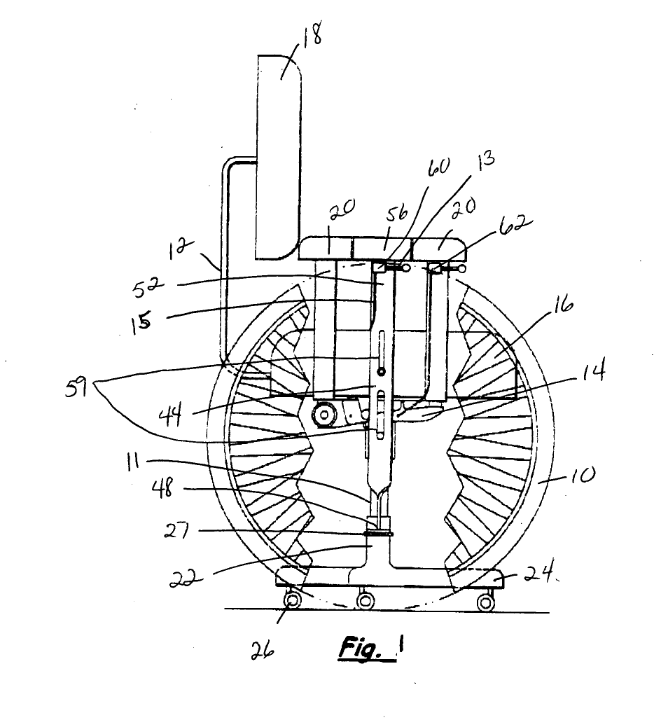

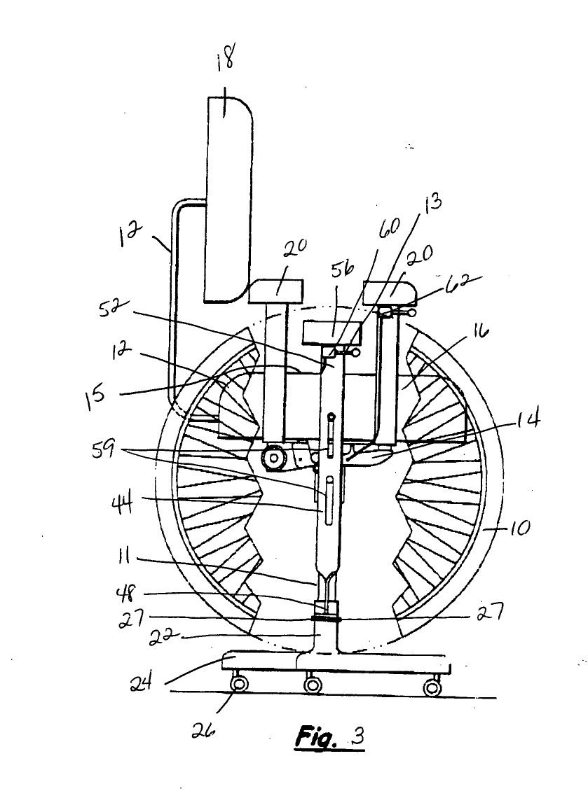

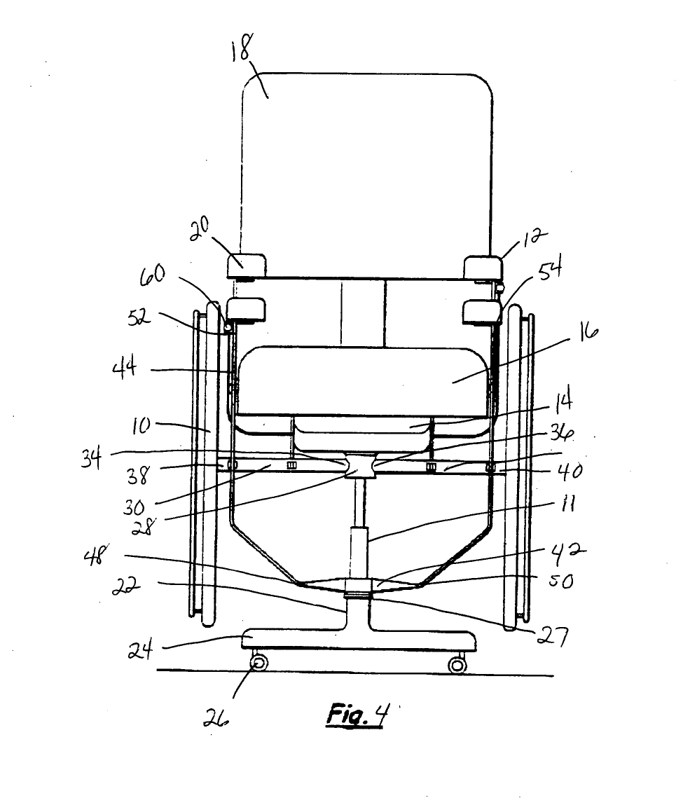

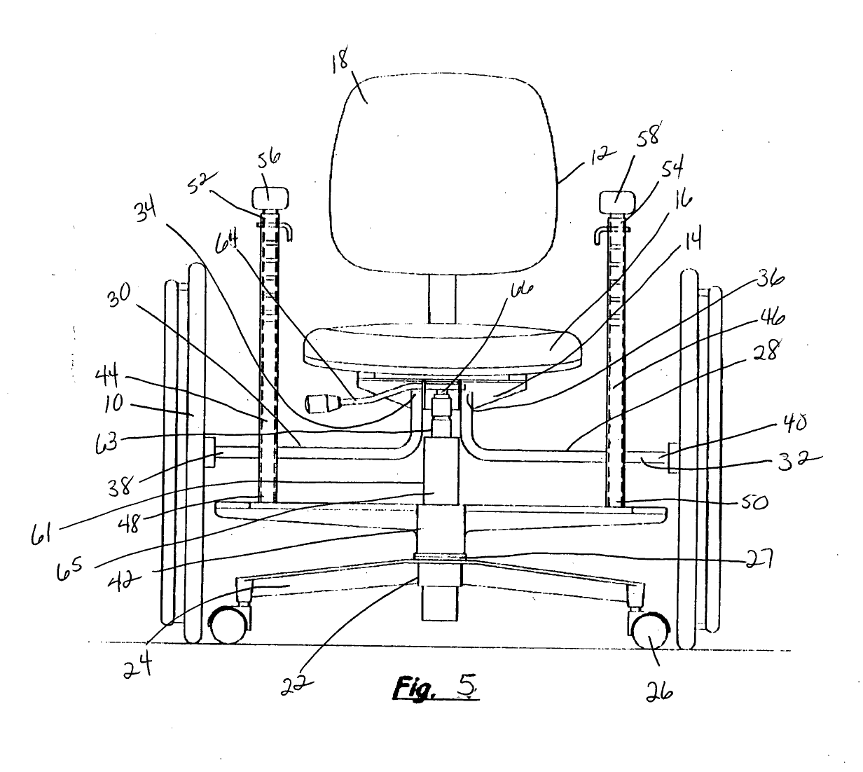

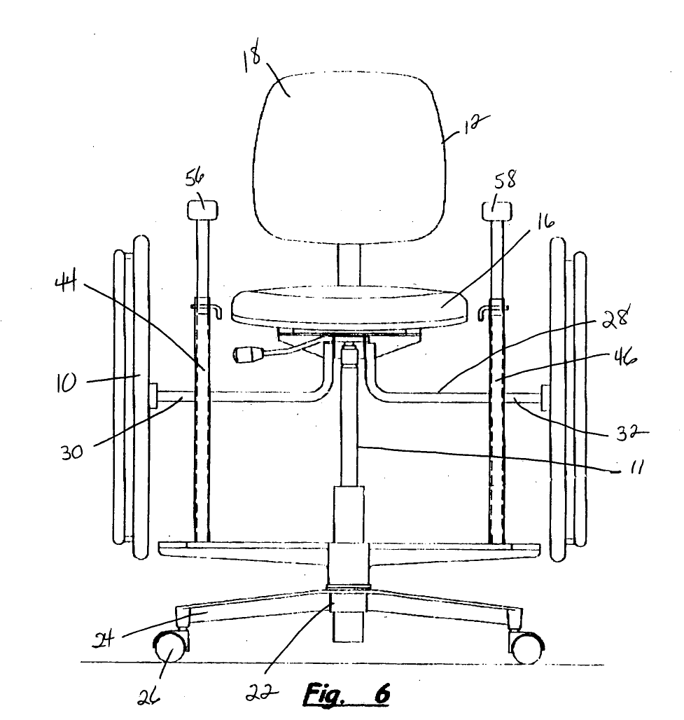

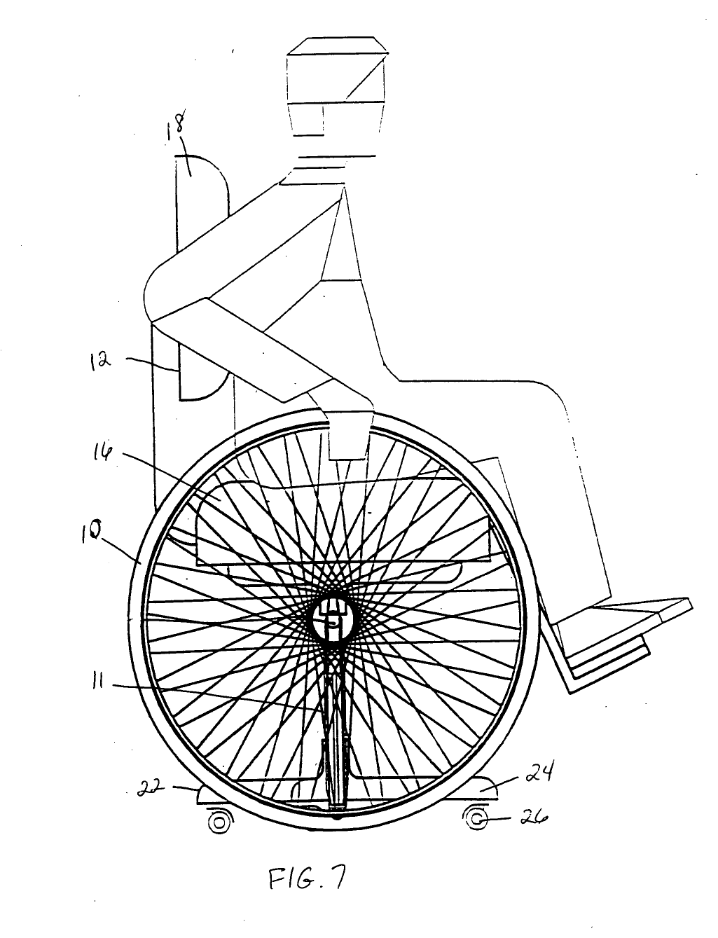

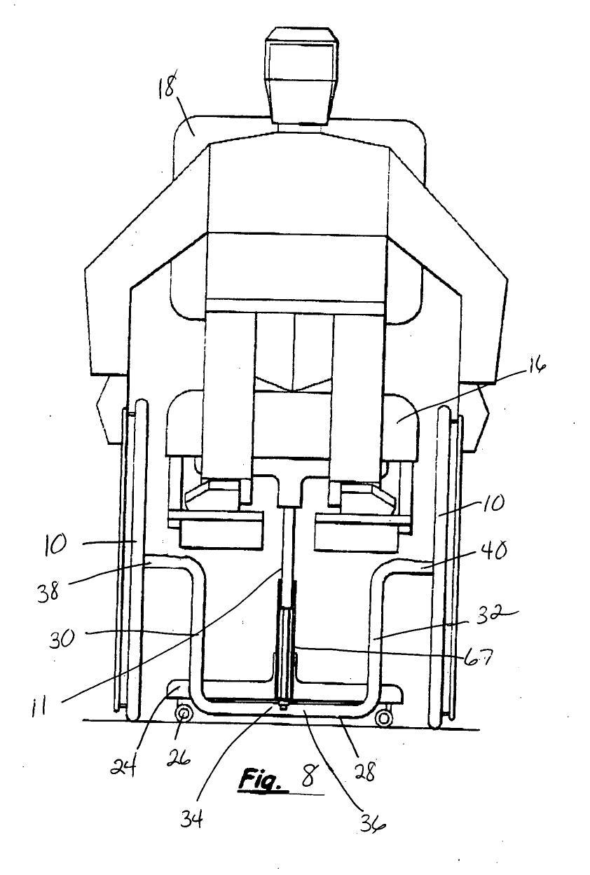

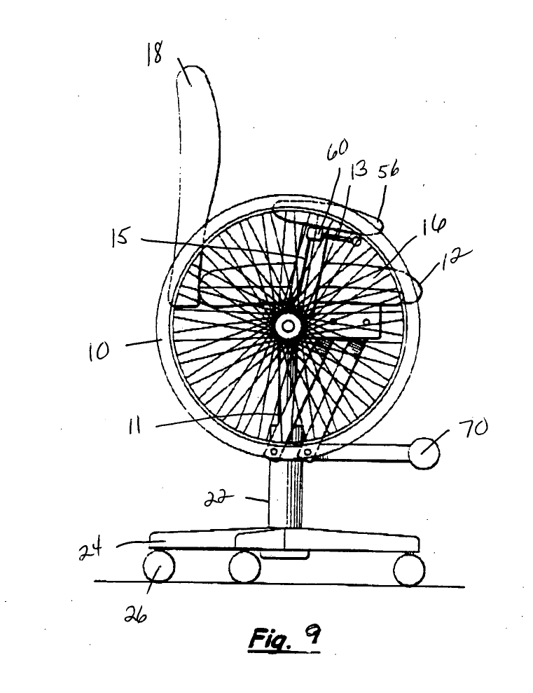

A preferred embodiment of the chair of the subject invention is shown in FIGS. 1-4. In this embodiment, the wheels 10 are mounted on the upper portion 12 of the chair. Therefore, when the height of the chair is adjusted upward, the wheels rise off the ground. The upper portion comprises a seat support mechanism 14 and a chair seat 16. The upper portion can further include a seat back 18 and arms 20. The upper portion 12 moves relative to the lower portion 22. The lower portion 22 includes a base 24 with at least three castors 26 which contact the floor. A swivel 27 can be included in the lower portion 22 to allow the push-off arm rest supporting mechanism to rotate.

Wheels are attached to the chair by a wheel supporting mechanism 28. Wheel support members 30, 32 connect to the upper portion 12 or lower portion 22 of the chair and extend in opposite directions from each other. A first end 34, 36 of each wheel support member 30, 32, respectively, attaches to the chair. A second end 38, 40 of each wheel support member 30, 32, respectively, receives wheels 10. The wheels rotate substantially parallel to each other and cannot swivel in relationship to one another.

In a particularly preferred embodiment, the wheeled work chair of the subject invention has a push-of arm rest supporting mechanism 42 that includes a pair of push-off arm rests 56, 58 which allows one seated on the chair to use for lifting their weight off the chair seat 16 so the seat can be raised. The push-off arm rest supporting mechanism is attached to the lower portion 22. The push-off arm rest supporting mechanism 42 includes push-off arm rest supports 44, 46. A first end 48, 50 of each support 44, 46 respectively, is secured to the lower portion 22. A second end 52, 54 of each support 44, 46 has push-off arm rests 56, 58. The push-off arm rests do not rise with the upper portion of the chair as the upper portion rises. The push-off arm rests can be detachable. Slots 59 allow upper portion components attached to the push-off arm rest supports to rise as the upper portion rises.

In the embodiment shown in FIG. 1, an actuation mechanism 60 locks and unlocks the height adjustment mechanism which controls movement of the upper portion 12 relative to the lower portion 22. The actuation mechanism 60 can be any type suitable to control the height adjustable mechanism. In this embodiment, the height adjustment mechanism 11 is a telescoping support mechanism 59 with an upper section 61 and a lower section 63 which move in parallel alignment and can be locked into position or unlocked for height adjustments. The actuation mechanism 60 controlling movement of these sections in this embodiment is a remote actuation mechanism using a lever 13 and a cable 15. An additional actuator 62 is shown on the chair in FIG. 1 and controls the tilt and positioning of the seat 16 and seat back 18.

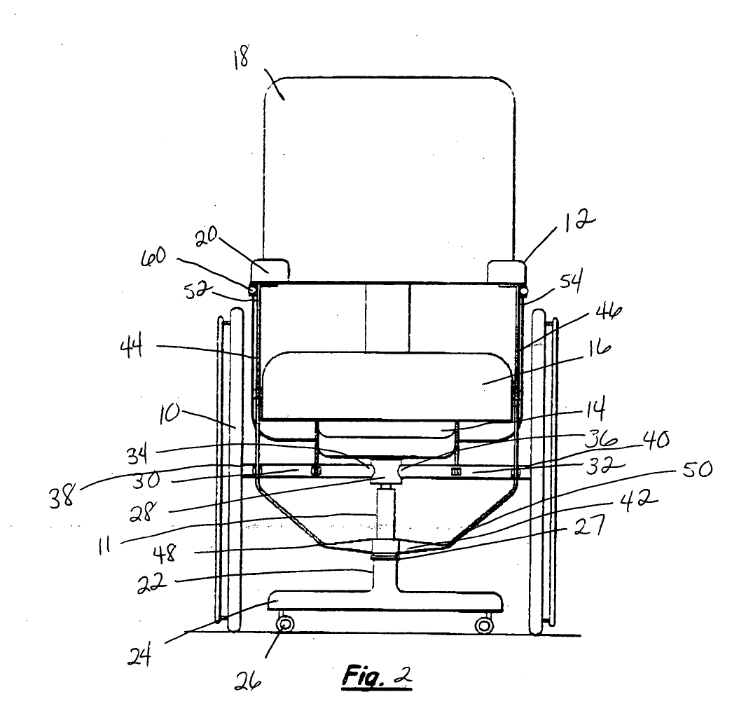

As previously stated, FIGS. 1-4 show a preferred embodiment of the subject chair with the wheels mounted on the upper moving portion. FIG. 1 shows a side view of the chair with the wheels 10 on the ground. FIG. 2 shows a front view of the same chair in that position. FIG. 3 shows a side view of the subject chair where the seat has been raised. The upper portion 12 of the chair including the seat support mechanism 14, the seat 16, the seat back 18, arms 20 and wheels 10 have moved within the slots 59 and away from the lower portion 22. With the wheels 10 raised off the ground the chair seat can swivel.

FIG. 5 shows another preferred embodiment of the wheeled work chair of the subject invention. The wheels 10 like the wheels on the chair in FIG. 1 are connected to the upper moving portion 12 of the chair. FIG. 5 shows the wheels on the ground. FIG. 6 shows the chair seat raised and the wheels off the ground. An actuation mechanism 64 is a lever that contacts an actuation button 66 on a telescoping support mechanism 59 to raise and lower the chair seat 16. In this embodiment, the push-off arm rest supports 44, 46 are height adjustable and can be raised or lowered.

Another preferred embodiment of the wheeled work chair of the subject invention is shown in FIG. 7. The subject chair, unlike conventional wheelchairs, does not have a traditional chair four-point frame supporting four wheels.

FIG. 8 shows a front view of another preferred embodiment of the wheeled work chair of the subject invention. In this embodiment, the wheels 10 are connected to the lower portion 22 of the chair and do not rise when the upper portion 12 moves away from the lower portion.

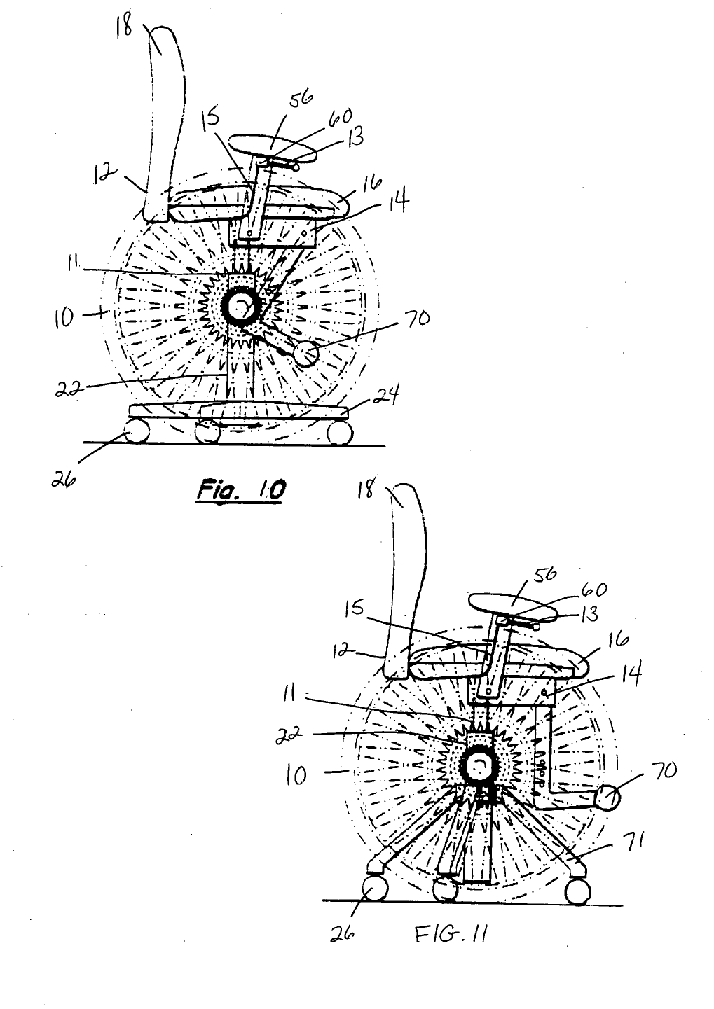

FIG. 9 shows another preferred embodiment of the subject invention. The wheels 10 are attached to and rise with the upper portion 22. This embodiment includes a footrest 70 to support the feet of a person seated in the chair (U.S. Pat. No. 6,196,631). FIG. 10 shows a similar chair where the wheels 10 are attached to the lower portion 22 of the chair. FIG. 11 shows a chair with a footrest 70 and wheels attached to the lower portion 22 which has a base 24 with three upwardly extending legs 71.

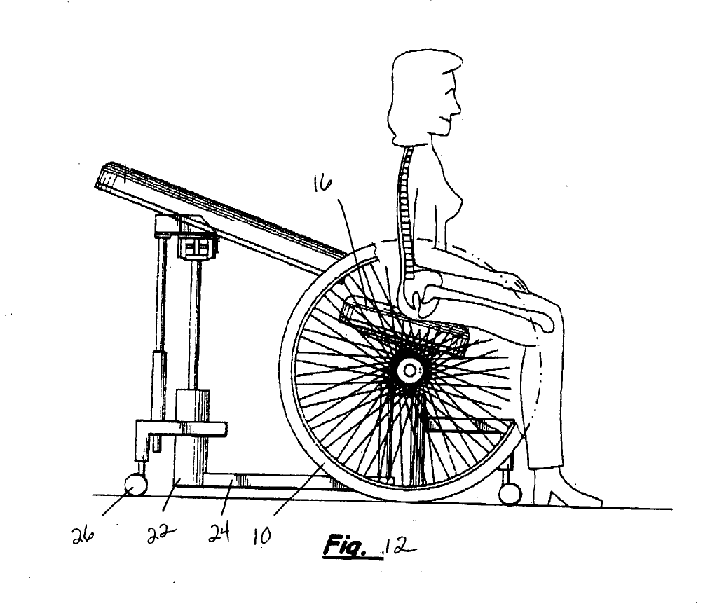

FIGS. 12-14 show another preferred embodiment of the chair of the subject invention. The chair (U.S. Pat. Nos. 5,186,519 and 5,330,254) has an upper portion 12 that moves relative to a lower portion 22. FIG. 12 shows the wheels 10 attached to the upper portion 12 of the chair which rises away from the lower portion 22 and base 24. FIGS. 13 and 14 show the wheels 10 attached to the lower portion 22 of the chair.

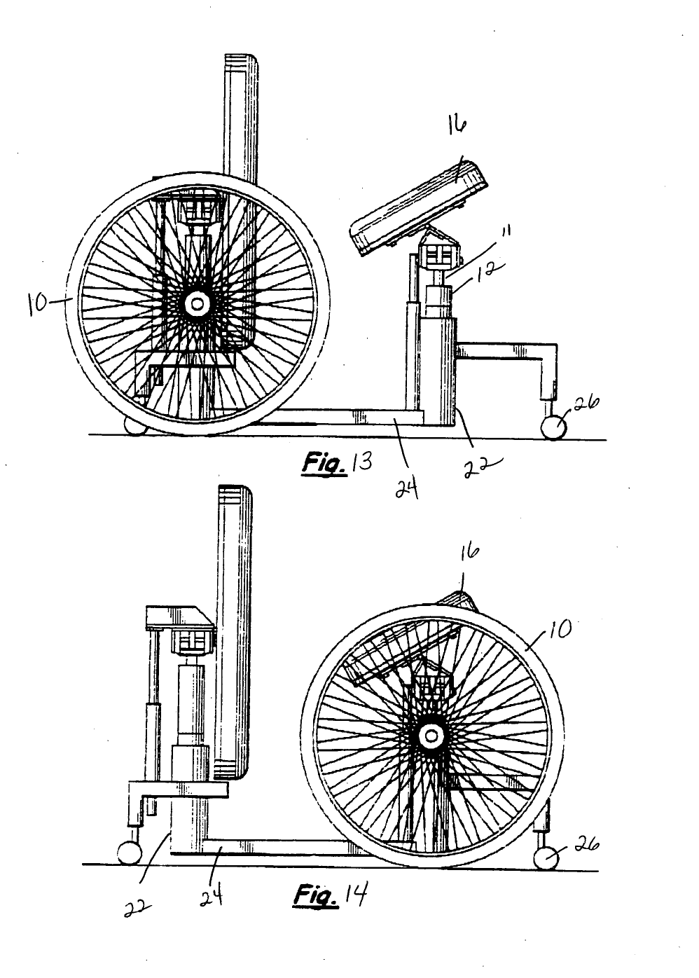

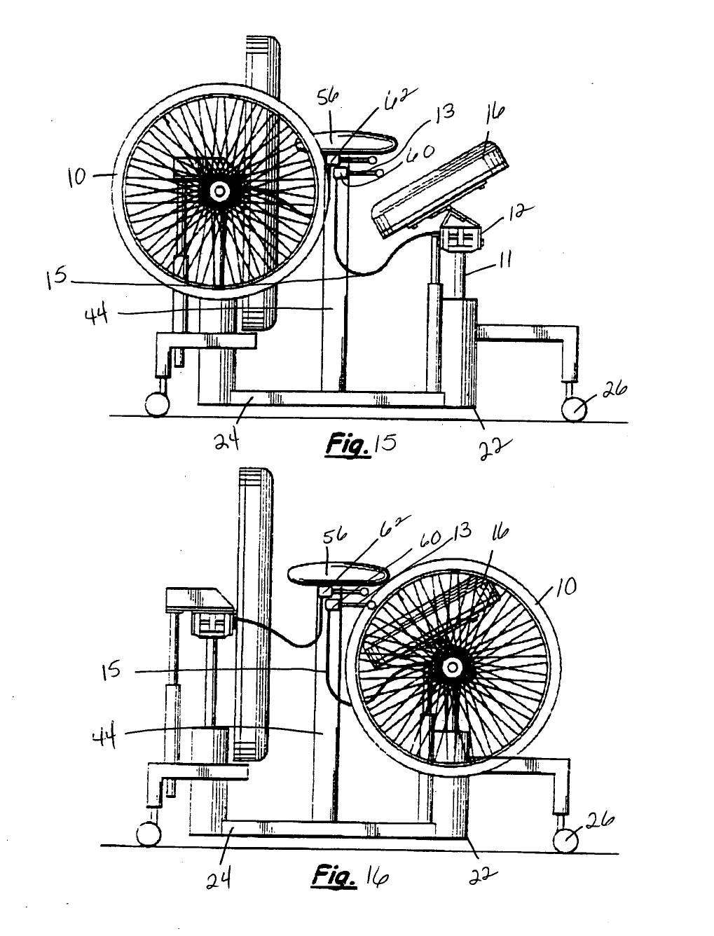

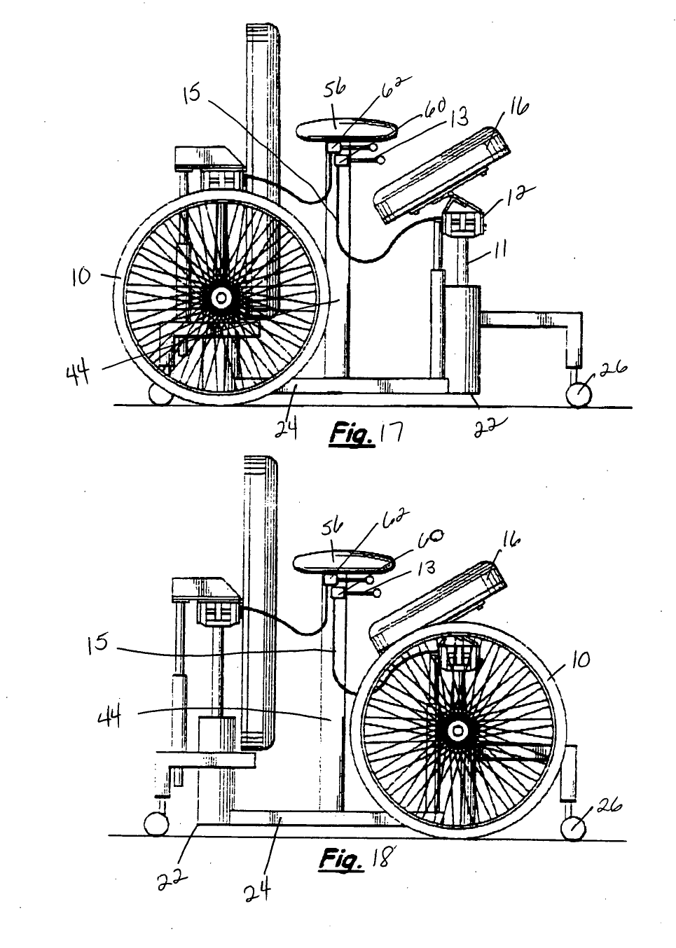

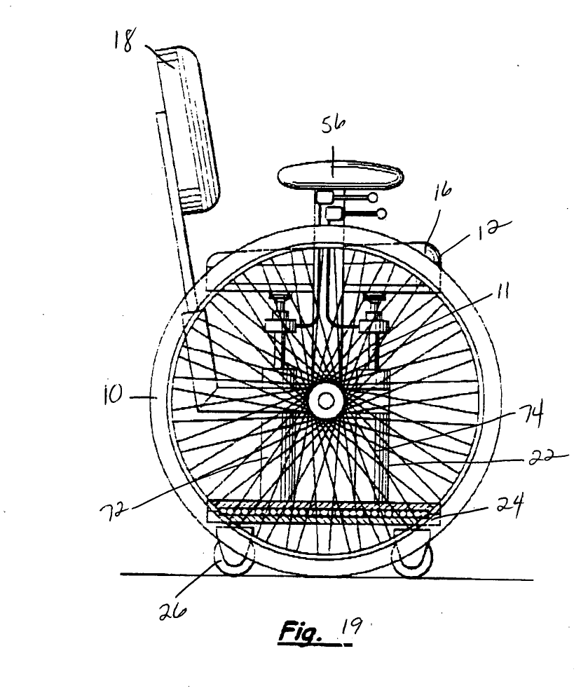

FIGS. 15-18 show another preferred embodiment of the height adjustable chair of the subject invention. The chair has push-off arm rests 56, 58 not shown, supported by push-off arm rest support 44, 46, not shown. A remote actuation mechanism 60 controls motion of the upper portion. FIGS. 15 and 16 show the wheels 10 connected to the upper portion 12 of the chair. FIGS. 17 and 18 show the wheels 10 connected to the lower portion of the chair.

FIG. 19 shows another preferred embodiment of the wheeled work chair of the subject invention. This embodiment has two telescoping support mechanisms 72, 74. The wheels 10 are attached to the lower portion 22 of the chair.

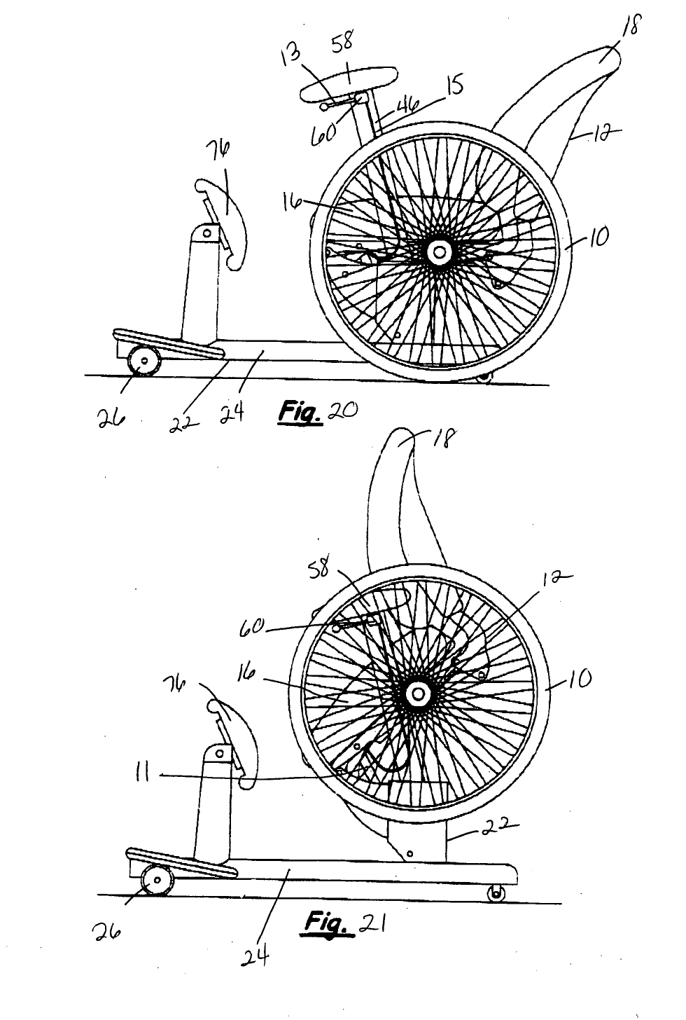

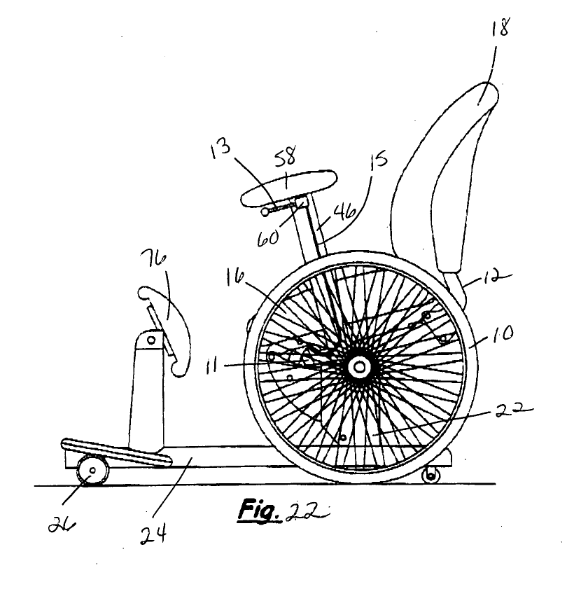

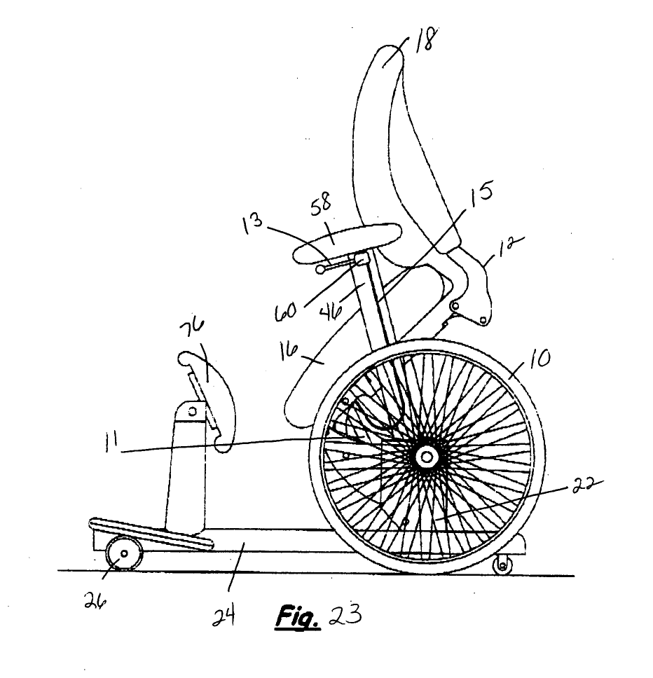

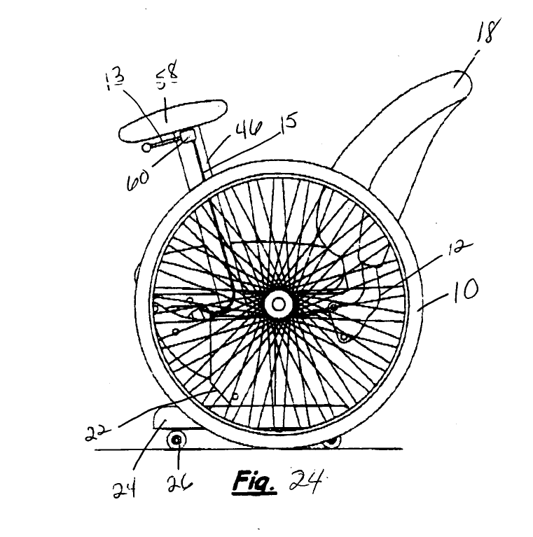

FIGS. 20-23 show another preferred embodiment of the wheeled work chair of the subject invention. The chair (U.S. Pat. Nos. 6,439,657 and 6,702,372) includes an upper portion 12 that moves relative to a lower portion 22. The upper portion includes a seat support mechanism 14, a chair seat 16 and a seat back 18. The lower portion includes a base 24 on castors 26 and a pivoting knee pad 76. The push-off arm rests have a remote actuator 60 and are secured to the lower portion 22. FIGS. 20 and 21 show the wheels connected to the upper portion of the chair. FIG. 21 shows the chair when the seat position has been moved. FIGS. 22 and 23 show the wheels connected to the lower portion of the chair. FIG. 23 shows the chair when the seat position has been moved.

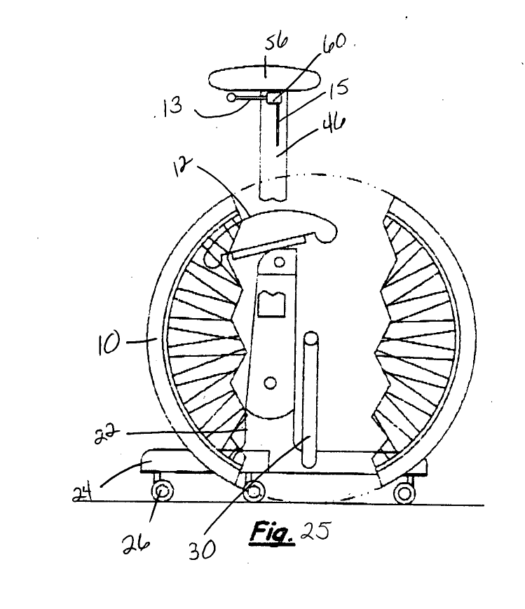

FIG. 24 shows another preferred embodiment of the wheeled work chair of the subject invention where the wheels are connected to the upper portion of the chair. FIG. 25 shows another preferred embodiment where the wheels are supported directly by the lower portion 22 with wheel support members 30, 32, not shown. The push-off arm rests 56, 58, not shown, are likewise supported directly by the lower portion and do not pivot.

It is understood that the foregoing examples are merely illustrative of the present invention. Certain modifications of the devices and/or methods employed may be made and still achieve the objectives of the invention. Such modifications are contemplated as within the scope of the claimed invention.

1. A wheeled work chair comprising:
a seat support mechanism;
a chair seat supported above said seat support mechanism and positioned by said seat support mechanism;
a base comprising a wheel supporting mechanism comprising first and second wheel support members wherein each wheel support member extends in opposite directions from each other, wherein each wheel support member comprises a first end, and a second end, a first wheel secured to said second end of said first wheel support member, and a second wheel secured to said second end of said second wheel support member, wherein each wheel can rotate, wherein said second ends of each wheel support member each comprise an axis upon which each wheel rotates, wherein said first and second wheels cannot swivel in relationship to each other, and wherein each wheel comprises an outer diameter which can contact and roll along a floor surface, and at least one castor, wherein said first and second wheels are positioned on said wheeled work chair convenient for a seated person to use his or her hands to move said wheels to move himself or herself about over a floor surface without use of his or her feet, wherein each castor swivels, and can contact and roll along a floor surface, an height adjustment mechanism disposed below said seat support mechanism;
wherein said chair seat and said seat support mechanism are supportedly positioned by said height adjustment mechanism; wherein said height adjustment mechanism can move; wherein movement of said height adjustment mechanism can result in changing the position of said chair seat relative to said base;
wherein said seat support mechanism is positionally supported by said base;
wherein said chair seat is supported above said seat support mechanism and is positioned by said seat support mechanism;
wherein said seat support mechanism is supported by said height adjustment mechanism, and secures said chair seat to said height adjustment mechanism;
wherein said height adjustment mechanism comprises at least one gas spring comprising first and second telescoping sections, wherein said first section comprises a cylinder, and said second section comprises a piston rod disposed within said cylinder and extending outwardly therefrom, a movable spring material comprising pressurized gas disposed within said cylinder; and a fluid flow control valve disposed within said cylinder, wherein the position of said chair seat can be changed relative to said base.

2. The wheeled work chair of claim 1, wherein at least one said gas spring comprises a locking gas spring comprising a movable fluid flow control valve stem extending outwardly from said locking gas spring; and an actuation button comprising the outwardly extending end of said movable fluid flow control valve stem; wherein said actuation button can be moved from a first locked position to a second unlocked position; wherein said unlocked position allows relative longitudinal movement between said cylinder and said piston rod, wherein said locking gas spring is actuated allowing said chair seat to be changed relative to said base.

3. The wheeled work chair of claim 1, comprising at least two locking gas springs, each comprising a movable fluid flow control valve stem extending outwardly from said locking gas spring, and an actuation button comprising the outwardly extending end of said movable fluid flow control valve stem, wherein said actuation button can be moved from a first locked position to a second unlocked position, wherein said unlocked position allows relative longitudinal movement between said cylinder and said piston rod, wherein said locking gas spring is actuated allowing said chair seat to be changed relative to said base.

4. The wheeled work chair of claim 1, wherein said base comprises a frame, wherein said frame can be supported by at least one of said at least one said castor and said first and said second wheels.

5. The wheeled work chair of claim 1, wherein said base comprises two castors.

6. The wheeled work chair of claim 1, wherein said base comprises an horizontal beam wherein said beam is supported by at least one of said at least one castor and said first and said second wheels.

7. The wheeled work chair of claim 1, wherein said height adjustment mechanism is disposed forward of said axes.

8. The wheeled work chair of claim 1, comprising a backrest supported by said height adjustment mechanism.

9. The wheeled work chair of claim 8, wherein said backrest can move angularly.

10. The wheeled work chair of claim 9, wherein said seat support mechanism can comprise a control mechanism for adjusting the angle of said backrest.

11. The wheeled work chair of claim 1, wherein said chair seat can move angularly.

12. The wheeled work chair of claim 9, wherein said chair seat can move angularly.

13. The wheeled work chair of claim I1, wherein said seat support mechanism can comprise a control mechanism for adjusting the angle of said chair seat.

14. The wheeled work chair of claim 12, wherein said seat support mechanism can comprise a control mechanism for synchronous adjustment of the angle of said chair seat and said backrest.

15. The wheeled work chair of claim 1, comprising at least one armrest supported by said height adjustment mechanism.

16. The wheeled work chair of claim 15, comprising an angularly adjustable backrest; wherein said armrest can comprise a control mechanism for adjusting the angle of said backrest.

17. The wheeled work chair of claim 1, comprising at least one push-off armrest supported by said base.

18. The wheeled work chair of claim 6, wherein said height adjustment mechanism is supported by said horizontal beam.

19. The wheeled work chair of claim 1, comprising an angularly movable backrest supported by said height adjustment mechanism; wherein the angle of said backrest can be adjusted by a control mechanism disposed above said height adjustment mechanism.

20. A wheeled work chair comprising:
a seat support mechanism;
a chair seat supported above said seat support mechanism and positioned by said seat support mechanism;
a base comprising a wheel supporting mechanism comprising first and second wheel support members wherein each wheel support member extends in opposite directions from each other, wherein each wheel support member comprises a first end, and a second end, a first wheel secured to said second end of said first wheel support member, and a second wheel secured to said second end of said second wheel support member, wherein each wheel can rotate, wherein said second ends of each wheel support member each comprise an axis upon which each wheel rotates, wherein said first and second wheels cannot swivel in relationship to each other, and wherein each wheel comprises an outer diameter which can contact and roll along a floor surface, and at least one castor, wherein said first and second wheels are positioned on said wheeled work chair convenient for a seated person to use his or her hands to move said wheels to move himself or herself about over a floor surface without use of his or her feet, wherein each castor swivels, and can contact and roll along a floor surface, an height adjustment mechanism disposed below said seat support mechanism;
wherein said chair seat and said seat support mechanism are supportedly positioned by said height adjustment mechanism; wherein said height adjustment mechanism can move; wherein movement of said height adjustment mechanism can result in changing the position of said chair seat relative to said base;
wherein said seat support mechanism is positionally supported by said base;
wherein said chair seat is supported above said seat support mechanism and is positioned by said seat support mechanism;
wherein said seat support mechanism is supported by said height adjustment mechanism, and secures said chair seat to said height adjustment mechanism;
wherein said height adjustment mechanism comprises at least one locking gas spring comprising first and second telescoping sections, wherein said first section comprises a cylinder, and said second section comprises a piston rod disposed within said cylinder and extending outwardly therefrom, a movable spring material comprising pressurized gas disposed within said cylinder, a fluid flow control valve stem extending outwardly from said locking gas spring, and an actuation button comprising the outwardly extending end of said fluid flow control valve stem; wherein said actuation button can be moved from a first locked position to a second unlocked position, wherein said unlocked position allows relative longitudinal movement between said cylinder and said piston rod, wherein said locking gas spring is actuated, wherein the position of said chair seat can be changed relative to said base.
